(19) United States
(12) Patent Application Publication
(10) Pub. No.: US 2019/0086857 A1
(43) Pub. Date: Mar. 21, 2019

(54) IMAGE FORMING APPARATUS AND IMAGE FORMING METHOD

(71) Applicants: KABUSHIKI KAISHA TOSHIBA, Tokyo (JP); TOSHIBA TEC KABUSHIKI KAISHA, Tokyo (JP)

(72) Inventor: Hiroyuki Tsuchihashi, Mishima Shizuoka (JP)

(21) Appl. No.: 15/711,065

(22) Filed: Sep. 21, 2017

(51) Int. Cl. G03G 15/00

(52) U.S. Cl. CPC G03G 15/6576; B65H 5/062; G03G 15/6511

(57) ABSTRACT

According to one embodiment, an image forming apparatus includes an image forming unit and a conveying unit. The image forming unit forms an image on a sheet-like medium. The conveying unit conveys the medium along a medium conveying route. The medium conveying route includes a first conveying path configured to pass through the image forming unit and a second conveying path connected to the first conveying path. When a processing condition of image forming processing satisfies a predetermined pre-processing condition, pre-processing of delivering the medium onto the second conveying path is performed before the image forming processing of forming an image on the medium by the image forming unit.

### FIELD

Embodiments described herein relate generally to an image forming apparatus and an image forming method.

### BACKGROUND

In the related art, an image forming apparatus and an image forming method in which an image is formed on a sheet-like medium are known. For example, the image forming apparatus includes a developing unit configured to develop an image which is to be formed, a transfer unit configured to transfer the developed image onto a surface of a medium, a fixing unit configured to fix the transferred image, and a conveying unit configured to transport a medium along a predetermined conveying path. The fixing unit includes a fixing roller configured to heat a medium, a press roller disposed to face the fixing roller, and a separation mechanism configured to separate the medium from the fixing roller. In such an image forming apparatus, for example, if borderless printing is performed or if a medium is thin, the medium may be wound around the fixing roller in accordance with a print condition, when the medium passes through a space between the fixing roller and the press roller, and thus conveyance failure such as jamming may occur.

An object of the embodiment is to provide an image forming apparatus and an image forming method in which conveying performance is high.

### DESCRIPTION OF THE DRAWINGS

FIG. 1 is a diagram illustrating a configuration of an image forming apparatus.

FIG. 2 is a diagram illustrating a configuration of a conveying route in the image forming apparatus.

FIG. 3 is a flowchart illustrating an image forming method according to the embodiment.

FIG. 4 is a diagram illustrating a conveying operation in a fixing unit of the image forming apparatus.

### DETAILED DESCRIPTION

In general, according to one embodiment, an image forming apparatus includes an image forming unit and a conveying unit. The image forming unit forms an image on a sheet-like medium. The conveying unit conveys the medium along a medium conveying route. The medium conveying route includes a first conveying path configured to pass through the image forming unit and a second conveying path connected to the first conveying path. When a processing condition of image forming processing satisfies a predetermined pre-processing condition, pre-processing of delivering the medium onto the second conveying path is performed before the image forming processing of forming an image on the medium by the image forming unit.

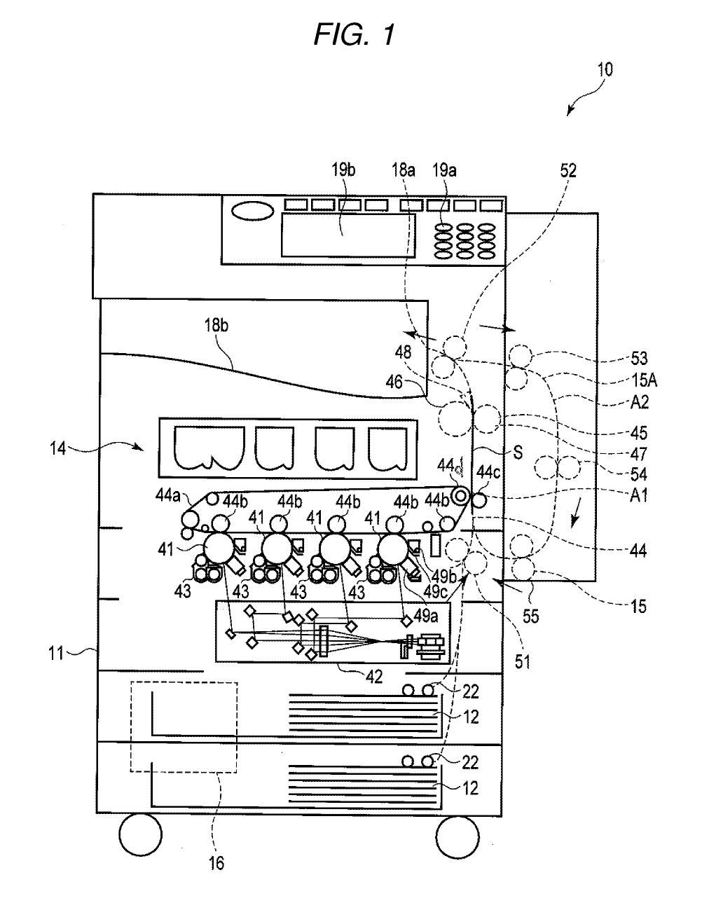

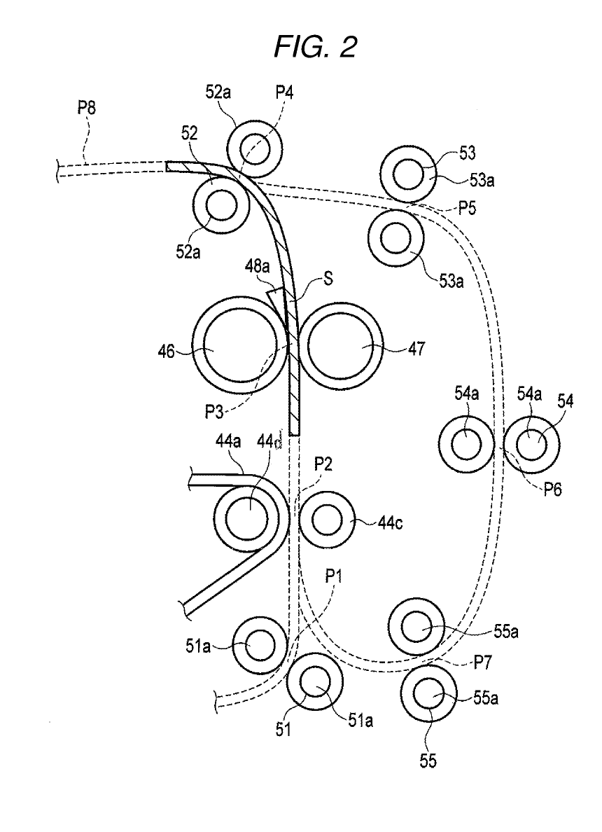

Hereinafter, an image forming apparatus 10 according to an embodiment will be described. FIG. 1 is a diagram illustrating the image forming apparatus 10. FIG. 2 is a diagram illustrating a configuration of a conveying route in the image forming apparatus 10.

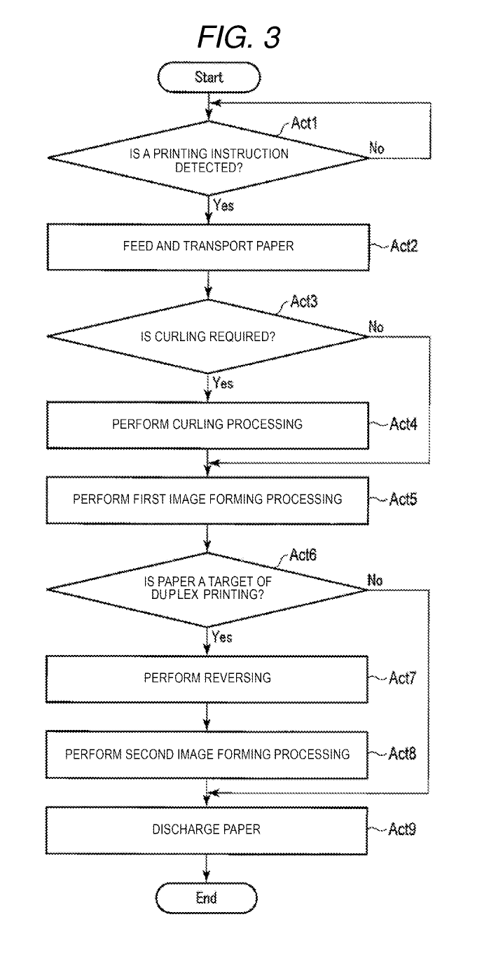

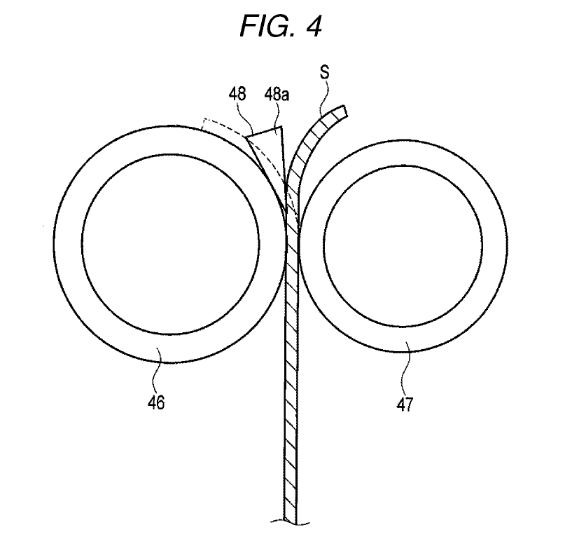

FIG. 3 is a flowchart illustrating an image forming method according to the embodiment. FIG. 4 is a diagram illustrating a conveying operation in a fixing unit.

As illustrated in FIG. 1, the image forming apparatus 10 includes a housing 11, a paper feeding unit 12 as a feeding unit, an image forming unit 14, a conveying unit 15, and a control unit 16. The conveying unit 15 delivers paper along a predetermined conveying route 15A. The image forming apparatus 10 forms an image on one side or both sides of paper S which is a sheet-like medium.

The housing 11 constitutes an outline of the apparatus. The paper feeding unit 12, the image forming unit 14, and the conveying unit 15 are accommodated in a space of the housing 11. The predetermined conveying route 15A is formed in the space of the housing 11. A discharge port 18a which communicates with the conveying route 15A is formed at a predetermined place of the housing 11. A discharge tray 18b is provided under the discharge port 18a of the housing 11. The discharge tray 18b includes a holding surface used for holding the paper S from the discharge port 18a. A control panel 19 is provided at an upper portion of the housing 11. The control panel 19 includes an input switch or an operation panel which allows a user to perform an input operation.

The paper feeding unit 12 includes a paper cassette 21 and a pickup mechanism 22. The paper cassette 21 has plural stages for holding plural sheets of paper S. The pickup mechanism 22 includes, for example, a pickup roller which is connected to the control unit 16 and rotates at a predetermined timing. In the pickup mechanism 22, the predetermined pickup roller rotates in a state of being in contact with the surface of paper S which is set in the paper cassette 21 and is positioned on the top. Thus, the paper is delivered, one by one, toward the image forming unit 14 on the downstream side along the conveying route 15A.

The image forming unit 14 forms an image on paper S. The image corresponds to image information input by an instruction or to image information read by a scanner that reads image data from an original document holding the image information. The image forming unit 14 is, for example, a color laser printer of the tandem type. The image forming unit 14 includes a photoconductive drum 41, an exposure device 42, a developing device 43, a transferring device 44, and a fixing device 45.

The photoconductive drum 41 and the developing device 43 are provided for each of colors of black, yellow, cyan, and magenta. A charger 49a, a developing device 43, a primary transfer roller 44b, a cleaner 49b, and a blade 49c are provided at the outer circumferential portion of the photoconductive drum 41 that holds a latent image, in a rotation direction. The charger 49a uniformly charges the entirety of the surface of the photoconductive drum 41.

The exposure device 42 includes a polygonal mirror, an imaging lens system, and a mirror. The exposure device 42 performs scanning with a laser beam emitted from a semiconductor laser element, in an axial direction of the photoconductive drum 41, and thus a latent image is formed on the photoconductive drum 41.

The developing device 43 includes a mixer and a developing roller. The mixer stirs a developer. A developing bias is applied to the developing roller. The developing device 43 supplies a toner to the photoconductive drum 41 by the developing roller, and develops the latent image formed on the photoconductive drum 41.

The transferring device 44 includes a transfer belt 44a, a primary transfer roller 44b, a secondary transfer roller 44c, and a belt roller 44d. The transfer belt 44a is delivered along a predetermined circulation path. The primary transfer roller 44b is used for applying a primary transfer voltage. The secondary transfer roller 44c is used for applying a secondary transfer voltage. Rotation of the belt roller 44d causes the transfer belt 44a to be delivered. The transferring device 44 transfers the toner image developed on the photoconductive drum 41, onto target paper S.

The fixing device 45 includes a fixing roller 46, a press roller 47, and a separation mechanism 48. The fixing roller 46 and the press roller 47 are disposed to face each other with the first conveying path A1 interposed between the fixing roller 46 and the press roller 47. The separation mechanism 48 separates paper from the fixing roller 46. The fixing roller 46 and the press roller 47 are connected to the control unit 16. A heater 46a configured to heat the fixing roller 46 is provided in the fixing roller 46. The fixing roller 46 is heated to a predetermined temperature by control of the control unit 16. Thus, the fixing roller 46 heats paper disposed between the fixing roller 46 and the press roller 47, and fixes a toner image on the paper S onto which the toner image is previously transferred.

The fixing roller 46 and the press roller 47 rotate at a predetermined speed by control of the control unit 16, and thus function as the conveying unit 15 that delivers the paper S.

The separation mechanism 48 includes a separation blade 48a which is provided at the outer circumferential portion of the fixing roller 46. In the separation blade 48a, a tip portion is disposed on an upstream side of a rotation direction, so as to be inclined toward the surface of the fixing roller 46. The separation blade 48a is entered between the fixing roller 46 and the paper S by the transport of the paper S. Thus, the separation blade 48a causes the paper S to be separated from the fixing roller 46 and guides the paper S to the downstream side.

The conveying unit 15 includes a plurality of conveying roller pairs 51 to 55 and a guide member. The conveying roller pairs 51 to 55 are provided along the conveying route 15A which includes the first conveying path A1 and the second conveying path A2. The guide member guides the paper S in a conveying direction.

The conveying roller pairs 51 to 55 are provided at a plurality of places on the conveying route 15A, respectively. The conveying roller pair 51 includes two conveying rollers 51a which face each other with the conveying route 15A interposed between the two conveying rollers 51A. The conveying roller pair 52 includes two conveying rollers 52a which face each other with the conveying route 15A interposed between the two conveying rollers 52a. The conveying roller pair 53 includes two conveying rollers 53a which face each other with the conveying route 15A interposed between the two conveying rollers 53a. The conveying roller pair 54 includes two conveying rollers 54a which face each other with the conveying route 15A interposed between the two conveying rollers 54a. The conveying roller pair 55 includes two conveying rollers 55a which face each other with the conveying route 15A interposed between the two conveying rollers 55a. The conveying rollers 51a, the conveying rollers 52a, the conveying rollers 53a, the conveying rollers 54a, and the conveying rollers 55a are connected to the control unit 16, and thus rotate at a predetermined timing by control of the control unit 16 so as to convey the paper S.

The conveying roller pair 52 which includes the conveying rollers 52a disposed at the discharge port 18a is configured to be rotatable clockwise and counterclockwise. The conveying rollers 52a rotate in one direction, and thus discharge the paper S on the first conveying path from the discharge port 18a. The conveying rollers 52a rotate in the opposite direction, and thus switch the paper S back. That is, the conveying rollers 52a also function as reversal roller. The conveying roller pairs 52 to 55 which are arranged on the second conveying path A2 perform switchback of the paper S conveyed from the image forming unit 14. The conveying roller pairs 52 to 55 cause the paper S to pass through the second conveying path A2 as a reversal path, so as to reverse the front and the back of the paper S. Then, the conveying roller pairs 52 to 55 deliver the paper S to the image forming unit 14 again.

The conveying route 15A includes the first conveying path A1 and the second conveying path A2. The first conveying path A1 is a path directing upward from the plurality of paper cassette 21 in an area on the lower side of the image forming apparatus 10 and reaching the discharge port 18a through the image forming unit 14. The second conveying path A2 is a path which is bent downward from the discharge port 18a and turns back to a second position P2 on an upstream side of the image forming unit 14.

The first conveying path A1 passes through a first position P1, the second position P2, a third position P3 between the fixing roller 46 and the press roller 47, and a fourth position P4, and then reaches an eighth position P8 on the outside of the discharge port 18a. The first position P1 is interposed between the rollers of the conveying roller pair 51. The second position P2 is a transfer position at which the transferring device 44 transfers the toner image onto the paper S. The fourth position P4 is interposed between the rollers of the conveying roller pair 52.

The second conveying path A2 is connected to the first conveying path A1. The second conveying path A2 is branched from a predetermined position on the first conveying path A1, on the downstream side of the fixing roller 46 on the first conveying path A1. The second conveying path A2 turns back to a predetermined position on the first conveying path A1, on the upstream side of the transferring device 44 on the first conveying path A1. The second conveying path A2 passes from the fourth position P4 interposed between the rollers of the conveying roller pair 52, which function as reversal roller, through the fifth position P5 interposed between the rollers of the conveying roller pair 53, the sixth position P6 interposed between the rollers of the conveying roller pair 54, and the seventh position P7 interposed between the rollers of the conveying roller pair 55. Then, the second conveying path A2 reaches the second position P2 again.

The control unit 16 includes a processor 16a and a memory 16b. The processor 16a controls operations of the units. The memory 16b stores a program, various types of data, and the like.

The processor 16a includes a central processing unit (CPU) and corresponds to the core part of the control unit 16. The processor 16a is to realize various functions of the image forming apparatus 10 and controls the operations of the units in the image forming apparatus 10, in accordance with an operating system or an application program.

The processor 16a performs control processing based on a control program which is previously recorded in the memory 16b, so as to control the operations of the units. For example, the processor 16a controls an operation of the conveying unit 15, and thus functions as the conveying unit configured to convey paper S. The processor 16a controls an operation of the image forming unit 14 based on image information, and thus functions as the image forming unit configured to form an image on paper S. The processor 16a controls a rotation speed of each of the conveying roller pairs 51 to 55 or controls a temperature of the heater configured to heat the fixing roller 46. Thus, the processor 16a functions as a curling unit configured to bend paper S by a predetermined amount of curling.

The memory 16b includes a read only memory (ROM) and a random access memory. The ROM stores various programs and the like. The RAM temporarily stores various types of variable data, image data, or the like. The memory 16b stores various control programs or various operation conditions, as information required for control of, for example, a conveying operation or an image forming operation of paper S.

The control panel 19 includes an input device 19a and a display device 19b. The input device 19a is an input unit configured to allow an input operation such as a printing instruction, which is performed by a user. The display device 19b displays various types of information or various images by control of the control unit 15. The control panel 19 is connected to the control unit 15.

The image forming processing in the image forming apparatus 10 according to the embodiment will be described below with reference to FIG. 3.

If the processor 16a detects an instruction to start printing, by an input operation of, for example, a user (Act 1), the processor 16a drives the paper feeding unit 12 so as to feed paper S having a size depending on settings of printing, onto the conveying route 15A (Act 2).

The processor 16a determines whether or not curling processing as the pre-processing is performed, based on a set condition of printing (Act 3). For example, the criterion for determining whether or not curling is required is previously set based on various processing conditions, and is stored in the memory 16b. For example, a predetermined condition in which it is difficult to easily separate paper S from the fixing roller 46 because the paper S is stuck to the fixing roller 46 in accordance with a case of borderless printing or a processing condition such as characteristics of a toner or characteristics of paper is set as a condition for requiring curling. In Act 3, when the detected printing processing condition satisfies a curling criterion which is previously set, the processor 16a determines that curling is required.

The processor 16a detects a condition of the curling processing when the curling processing is required, in Act 3. As the condition of the curling processing, for example, various conditions such as the temperature of the fixing roller and a conveying speed are provided. The condition of the curling processing is set as a condition depending on the required amount of curling, that is, the degree of bending.

When it is determined that the curling processing is required, in Act 3 (Yes in Act 3), the processor 16a delivers paper S which is not subjected to the image forming processing, to the reversal path, and then performs the curling processing before the image forming processing (Act 4). In Act 4, the processor 16a drives the conveying rollers 51 to 55 and the fixing device 45, so as to deliver paper S from the paper feeding unit 12 along the first conveying path A1. The paper S is delivered to the fourth position P4 through the first position P1, the second position P2, and the third position P3.

In Act 4, the processor 16a does not operate the exposure device 42, the developing device 43, or the transferring device 44.

As the process of Act 4, the processor 16a causes the conveying roller 52 as the reversal roller to be reversely rotated, in a state where a portion of the paper S is discharged from the discharge port 18a. Thus, the processor 16a performs switchback of the paper S, and causes the paper S to be delivered to the second conveying path A2.

The processor 16a controls a heating temperature of the fixing roller 46 or rotation speeds of the conveying roller pairs 51 to 55 and the fixing roller 46, based on a curling condition. The paper S is heated when passing through the space between the fixing roller 46 and the press roller 47. Then, when the temperature is lowered, the paper S is bent so as to have a posture along the shape of the second conveying path A2. Thus, the paper S is curled.

Here, as illustrated in FIG. 3, the second conveying path A2 as the reversal path is bent in an opposite direction of a bent shape of a portion of the fixing roller 46, which comes in contact with the paper S. Accordingly, as illustrated in FIG. 4, the paper S is curled, and thus warps toward an opposite side of a direction in which the paper S is wound around the fixing roller 46 in the subsequent image forming processing.

Then, the processor 16a performs first image forming processing of forming an image on one surface of the paper S, as the process of Act 5. Since the paper which is previously subjected to curling processing is fed in a state of being reversed, a surface positioned on a lower side in the paper feeding unit 12 becomes a printing surface of the first image forming processing. The paper S which is not subjected to the curling processing is not reversed. Thus, the surface positioned on an upper side in the paper feeding unit 12 becomes the printing surface of the first image forming processing.

As the first image forming processing, the processor 16a drives the image forming unit 14 and the conveying unit 15 at a predetermined timing. Specifically, the processor 16a drives the exposure device 42, and thus image light (exposure light) which is used for forming an image on the photoconductive drum 41 and corresponds to image data is output by the exposure device 42.

Thus, an electrostatic image (electrostatic latent image) corresponding to the exposure light from the exposure device 42 is formed on the photoconductive drum 41. The electrostatic latent image formed on the photoconductive drum 41 is developed with the toner held by the developing device 43, and is visualized.

The processor 16a drives the transferring device 44 at a predetermined timing, so as to cause the toner image on the photoconductive drum 41, that is, an output image to be transferred onto the paper S which is conveyed. As transfer processing, the transferring device 44 causes the primary transfer roller 44b to apply the primary voltage, and thus transfers the toner image on the photoconductive drum 41 onto the transfer belt 44a. When the paper S passes through a space between the secondary transfer roller 44c and the belt roller 44d, the transferring device 44 causes the secondary transfer roller 44c to apply a secondary transfer voltage, and thus secondarily transfers the toner image on the transfer belt 44a onto the paper S.

The toner image (output image) transferred onto the paper S is heated and pressed so as to be fixed onto the paper S in the fixing device 45. The toner image is fixed in the fixing device 45, and then image forming on one surface is ended. The fixed paper S is separated by the separation mechanism 48 provided at an outer circumference of the fixing roller 46, and is delivered toward the downstream side.

Here, as indicated by a solid line in FIG. 4, the paper S curled in Act 4 warps in a direction of becoming far from the fixing roller 46. Thus, it is possible to prevent winding around the fixing roller 46.

In Act 6, the processor 16a detects the processing condition based on an input instruction, and detects whether or not the paper S as a processing target is a target of duplex printing.

When the paper S is the target of the duplex printing (Yes in Act 6), the processor 16a causes the paper S to be delivered to the second conveying path A2 as the reversal path and to be reversed (Act 7).

After reversing processing, the processor 16a causes the reversed paper S to be delivered again from the second position P2 to the image forming unit 14. Thus, the processor 16a performs second image forming processing in a manner similar to the first image forming processing (Act 8). In the second image forming processing, the image forming processing is performed on the back surface which is an opposite surface of the surface used in the first image forming processing. The paper S on which an image is formed on one surface in the first image forming processing is reversed by passing through the second conveying path A2 as the reversal path in Act 8. Then, the paper S is delivered again to the second position P2. Then, similar to Act 5, the image forming processing is performed, and thus an image is formed on the other surface of the paper S.

When the paper S is not the target of the duplex printing in Act 6 (No in Act 6), the processor 16a causes the process to proceed to Act 9.

As the process of Act 9, the processor 16a causes the conveying roller pair 52 to rotate, such that the paper S which is a target of simplex printing and is subjected to the first image forming processing or the paper S which is the target of duplex printing and is subjected to the second image forming processing is discharged from the discharge port 18a. The paper S discharged from the discharge port 18a is supplied onto the discharge tray.

In the image forming apparatus 10 according to the embodiment, an image is not formed on paper firstly, but the paper is caused to pass through the reversal path when the predetermined processing condition such as a case of borderless printing is satisfied. Accordingly, since the fixing device 45 heats the paper and the paper is bent on the reversal path, it is possible to curl the paper S before the image forming processing. Therefore, in the subsequent image forming processing, when the paper S, after developing and transferring are performed, is fixed, the tip end of the paper warps in the direction of becoming far from the fixing roller 46. Thus, it is possible to prevent winding around the fixing roller 46. That is, for example, when a printing area is large, for example, as in a case of borderless printing, if the curling processing as the pre-processing is not performed, a toner is applied up to a position close to the tip end of paper S. Thus, as indicated by a broken line in FIG. 4, an occurrence of a situation in which separation of the tip end of the paper S is not possible and the paper is wound around the fixing roller 46 is considered. However, according to the image forming apparatus 10 of the embodiment, the paper is caused to have a tendency of previously warping toward an opposite side of a winding direction. Accordingly, it is possible to prevent winding of the paper S.

The image forming apparatus 10 is configured to allow control of the transport speed of the conveying unit or the heating temperature of the fixing roller in accordance with the processing condition. Accordingly, it is possible to easily control the amount of curling and to obtain the amount of curling, which is suitable for the processing condition.

The image forming apparatus 10 can perform curling by using the reversal path used in duplex printing or using the fixing roller 46, or can control the amount of curling. Accordingly, it is possible to improve conveying performance without an increase in the size of the apparatus or complexification of the apparatus, by effectively using the established facilities.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image forming apparatus comprising:
an image forming unit configured to form an image on a sheet-like medium;
a conveying unit configured to convey the sheet-like medium along the sheet-like medium conveying route which includes a first conveying path configured to pass through the image forming unit and a second conveying path connected to the first conveying path; and
a control unit configured to perform pre-processing of delivering the sheet-like medium onto the second conveying path from the first conveying path before image forming processing of forming an image on the sheet-like medium by the image forming unit,
wherein in response to performing the pre-processing, the image forming unit does not form the image on the sheet-like medium during conveyance using the first conveying path, wherein the second conveying path curls the sheet-like medium to be a curled sheet-like medium, and wherein the image forming unit forms the image on the curled sheet-like medium.

2. The apparatus according to claim 1,
wherein the image forming unit includes a transfer unit configured to transfer a toner image to a surface of the sheet-like medium disposed on the first conveying path, and a fixing unit configured to include a fixing roller which is disposed on a downstream side of the transfer unit on the first conveying path.

3. The apparatus according to claim 2,
wherein the second conveying path is branched from the first conveying path at a predetermined position on the downstream side of the fixing unit on the first conveying path, and is provided to turn back toward an upstream side of the transfer unit on the first conveying path, and
the second conveying path includes a reversal path which is bent in a direction opposing a portion of the fixing roller, which faces the sheet-like medium, and causes the front and the back of the sheet-like medium to be reversed to each other.

4. The apparatus according to claim 1, further comprising:
an input unit configured to allow an input of the processing condition,
wherein the control unit controls an operation of conveying the sheet-like medium, based on an input instruction to the input unit.

5. The apparatus according to claim 1,
wherein, when the sheet-like medium is a target of borderless printing, the control unit performs the pre-processing.

6. The apparatus according to claim 1,
wherein the control unit controls the temperature of the fixing roller in the pre-processing, based on the processing condition of the image forming processing.

7. The apparatus according to claim 1,
wherein the control unit controls a conveying speed in the pre-processing, based on the processing condition of the image forming processing.

8. An image forming method comprising:
conveying processing of conveying a sheet-like medium along a sheet-like medium conveying route which includes a first conveying path configured to pass through an image forming unit configured to form an image on the sheet-like medium, and a second conveying path configured to be branched from the first conveying path on a downstream side of the image forming unit on the first conveying path and to turn back toward an upstream side of the image forming unit on the first conveying path;
image forming processing of forming an image on a surface of the sheet-like medium which passes through the image forming unit; and
pre-processing of delivering the sheet-like medium along the second conveying path from the first conveyance path before the image forming processing,
wherein, in response to performing pre-processing, the image forming processing does not form the image on the sheet-like medium during conveyance using the first conveyance path, wherein the second conveying path curls the sheet-like medium to be a curled sheet-like medium, and wherein the image forming processing forms the image on the curled sheet-like medium.

9. The method according to claim 8,
wherein the second conveying path includes a reversal path which is bent in a direction opposing a portion of the fixing roller, which faces the sheet-like medium, and causes the front and the back of the sheet-like medium to be reversed to each other.

10. The method according to claim 8,
wherein the pre-processing condition is adjusted based on the processing condition of the image forming processing.

11. The image forming apparatus of claim 1, further comprises
a fixing unit that heats the sheet-like medium on which no image is formed when the sheet-like medium is conveyed along the first conveying path.

12. The method according to claim 8,
wherein the sheet-like medium on which no image is formed is heated when the sheet-like medium is conveyed along the first conveying path.
